(19) United States
(12) Patent Application Publication
(10) Pub. No.: US 2004/0179623 A1
(43) Pub. Date: Sep. 16, 2004

(54) Differential error detector

(76) Inventor: William Harrell Huckeba, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/388,913

(22) Filed: Mar. 14, 2003

(51) Int. Cl. H04B 3/00

(52) U.S. Cl. 375/257

(57) ABSTRACT

A differential error detector includes a first DC coupler having a signal input that receives a first signal component of a differential signal representing a predesignated series of logic states, and a second DC coupler having a signal input that receives a second signal component of the differential signal representing a complement of the series of logic states, wherein at least two types of logic bits are encoded according to at least two corresponding differential amplitudes between the first signal component and the second signal component. A DC source coupled between a bias input of the first DC coupler and a bias input of the second DC coupler imposes an offset between the first signal component and the second signal component. The offset selectively reduces the differential amplitude of one of the types of encoded logic bits between a signal output of the first DC coupler and a signal output of the second DC coupler. The differential error detector also includes a differential receiver coupled to the signal outputs of the DC couplers, extracting a decoded series of logic states and comparing the decoded series of logic states to the predesignated series of logic states represented in the differential signal. The aspects of the differential error detector are alternatively implemented according to a differential error detection method.

### BACKGROUND OF THE INVENTION

In many digital communication links, bits are encoded in high speed differential signals. When differential receivers process these differential signals, reference points can be established using virtual grounds. Virtual grounds are advantageous over the physical grounds relied upon by single-ended receivers that introduce noise and other interference onto the differential signals, typically due to imbalances in ground currents and other unwanted signals at the physical grounds. Such noise or interference can compromise the ability of a single-ended receiver to accurately determine the logic state of bits encoded in the differential signals. In addition to having the advantage of the virtual grounds, differential receivers also have the advantage of rejecting common-mode noise and interference that could impair the digital communication link.

A fundamental measure of the performance for a digital communication link is how accurately the logic state of the bits encoded in the differential signals can be determined by a receiver. Bit-error ratio, or BER, equal to the number of bits received in error over time relative to the total number of bits transmitted over time, is a figure of merit for this fundamental performance measure. A prior art scheme for characterizing the BER of a differential signal is shown in FIG. 1. In this scheme, the differential signal 3 is split into two unbalanced single-ended signals 5a, 5b. The single-ended signal 5b is terminated by a matched load, while the single-ended signal 5a is applied to a conventional single-ended error tester, such as an AGILENT TECHNOLOGIES, INC. model 86130 BITALYZER, which includes receiver Rx and an error detector. The error tester establishes an error rate for the single-ended signal 5a as a function of a threshold voltage V_{T} that is provided to a reference input of the receiver Rx. The BER for the differential signal 3 is then extracted from the error rate established for the single-ended signal 5a. However, splitting the applied differential signal 3 into the single-ended signals 5a, 5b according to this prior art scheme reduces the accuracy of the BER measurement because immunity to common-mode noise and interference is compromised, and physical grounds G1-G3 are imposed in place of a virtual ground (not shown) that would be present were a differential arrangement employed.

### SUMMARY OF THE INVENTION

A differential error detector constructed according to the embodiments of the present invention provides the advantages of virtual grounds and common mode rejection when processing differential signals encoding two or more types of logic bits according to differential amplitudes between the first signal component and the second signal component of the differential signal. The differential error detector includes a first DC coupler that receives the first signal component representing a predesignated series of logic states, and a second DC coupler that receives the second signal component representing a complementary series of logic states. A DC source coupled between the first DC coupler and the second DC coupler imposes an offset between the first signal component and the second signal component. The offset selectively reduces the differential amplitude of one of the types of encoded logic bits between a signal output of the first DC coupler and a signal output of the second DC coupler. A differential receiver coupled to the signal outputs extracts a decoded series of logic states and compares the decoded series of logic states to the predesignated series of logic states represented in the differential signal. Based on the comparison, various measures of errors, or deviations between the decoded series of logic states and the predesignated series of logic states, can be established. In an alternative embodiment of the present invention, the aspects of the differential error detector are implemented according to a differential error detection method.

### BRIEF DESCRIPTION OF THE DRAWINGS

FIG. 1 shows a prior art scheme for characterizing bit error ratio of a differential signal.

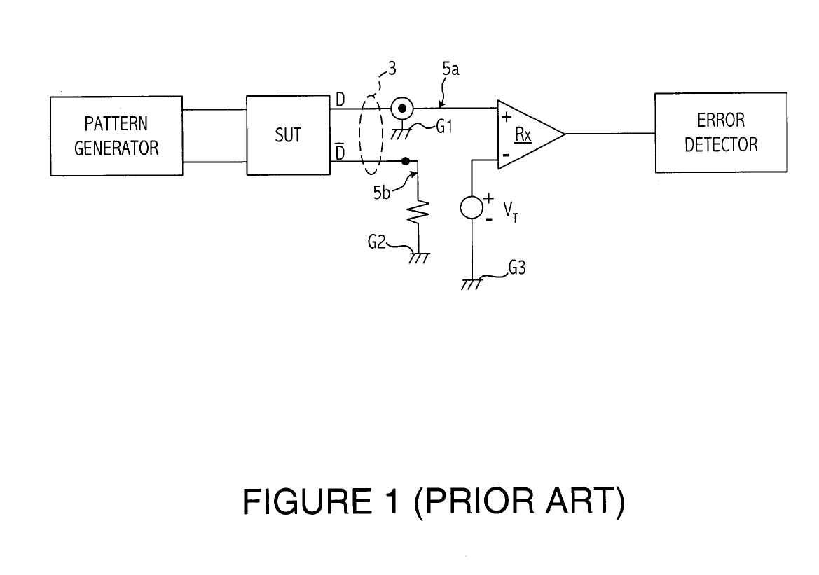

FIG. 2 shows a differential error detector according to an embodiment of the present invention.

FIGS. 3A-3E show an example of a differential signal suitable for processing by the differential error detector of FIG. 2.

FIG. 4 shows an example error profile for the differential error detector of FIG. 2.

FIG. 5 shows an example error contour for the differential error detector of FIG. 2.

FIG. 6 shows a differential error detection method according to an alternative embodiment of the present invention.

### DETAILED DESCRIPTION OF THE EMBODIMENTS

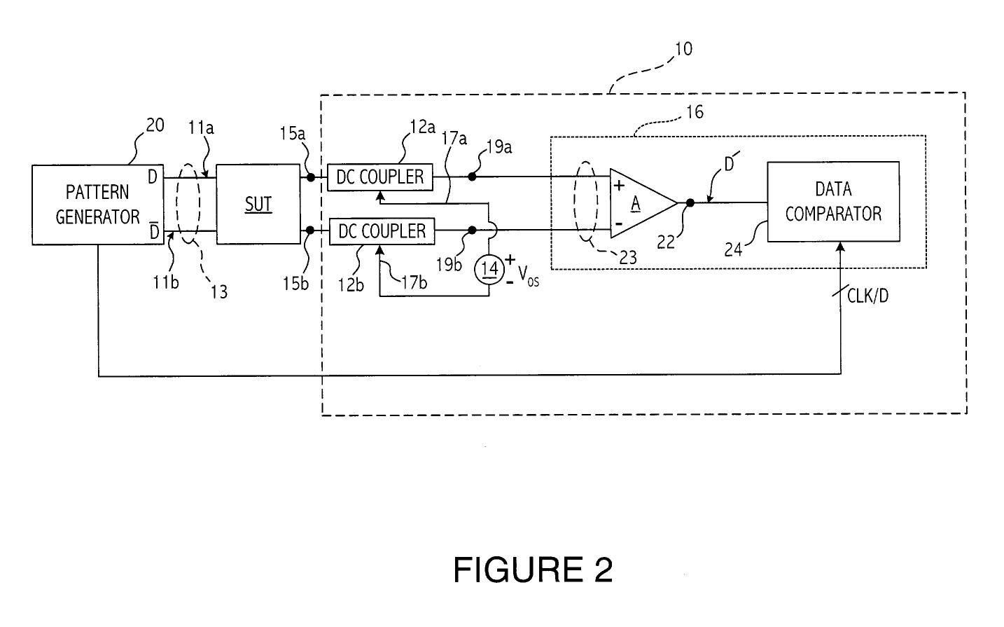

FIG. 2 shows a differential error detector 10 for differential signals, in accordance with an embodiment of the present invention. The differential error detector 10 includes a pair of DC couplers 12a, 12b, a DC source 14 and a differential receiver 16.

The DC coupler 12a has a signal input 15a receiving a signal component 11a of a differential signal 13 that represents a predesignated series of logic states D, whereas the DC coupler 12b has a signal input 15b receiving a signal component 11b of the differential signal 13 that represents the complementary series of logic states \overline{D}. Typically, the DC couplers 12a, 12b are bias tees. However, other level-shifting circuits or networks suitable for imposing a relative amplitude offset or shift between the signal component 11a and the signal component 11b are alternatively used.

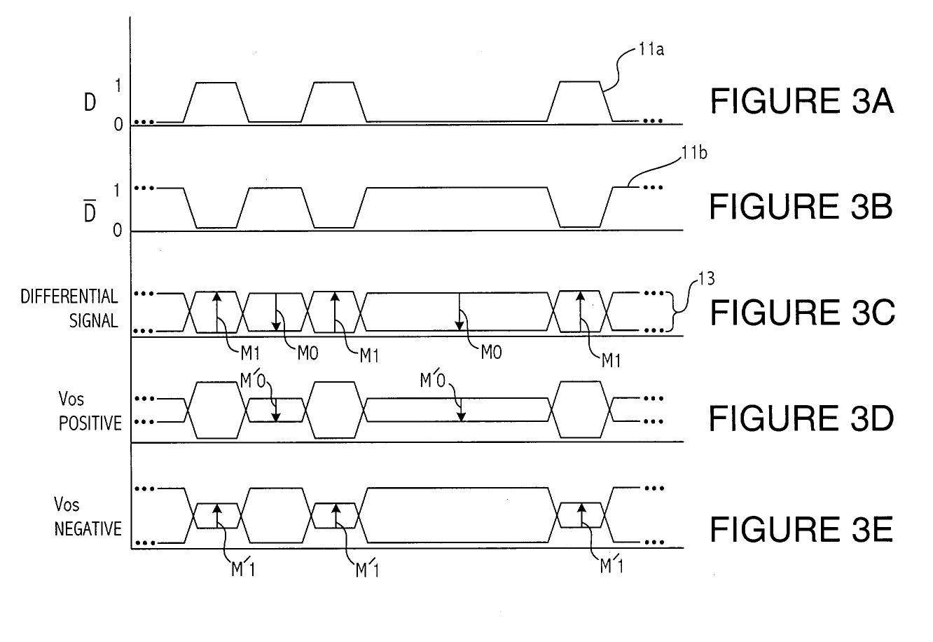

Together, the series of logic states D of the signal component 11a (shown in FIG. 3A) and the complementary series of logic states \overline{D} of the signal component 11b (shown in FIG. 3B) encode a sequence of logic “0” bits and “1” bits, for example a pseudo-random bit sequence (PRBS), based on differential amplitudes M0, M1 between the signal component 11a and the signal component 11b, respectively, as shown in FIGS. 3C-3E. In FIG. 3C, the differential amplitudes are indicated by the vectors M0, M1 that have both magnitudes and polarities. The differential amplitude M0 represents the logic “0” bit, wherein the signal component 11a has a lower amplitude than the signal component 11b. The differential amplitude M1 represents the logic “1” bit, wherein the signal component 11a has a higher amplitude than the signal component 11b. In the example of FIGS. 3A-3E, two types of logic bits, the logic “0” bit and the logic “1” bit are shown. However, a variety of types of multi-state logic bits can be encoded by corresponding differential amplitudes and represented by the differential signal 13. The differential signal 13 is typically provided by a pattern generator 20 or other data source suitable for generating the predesignated series of data states D and the complementary series of data states \overline{D}. In the example shown in FIG. 2, the differential signal 13 is applied to a system under test (SUT) such as a communication channel, amplifier, or other element, system or network component. The error detector 10 is coupled to the output of the SUT.

The DC source 14 is coupled between a bias input 17a of the DC coupler 12a and a bias input 17b of the DC coupler 12b. The DC source 14 imposes an offset V_{OS} between the signal components 11a, 11b and results in a differential signal 23 between a signal output 19a of the first DC coupler 12a and a signal output 19b of the second DC coupler 12b. Depending on the polarity of the imposed offset V_{OS}, either the differential amplitudes MO of the logic “0” bits are reduced, resulting in the differential amplitudes M′0 as shown in FIG. 3D, or the differential amplitudes of the logic “1” bits are reduced, resulting in differential amplitudes M′1 as shown in FIG. 3E. For example, when the imposed offset V_{OS} between the signal component 11a and the signal component 11b is positive, the differential amplitude MO of the logic “0” bits are reduced to the differential amplitude M′0. Conversely, when the imposed offset V_{OS} between the signal component 11a and the signal component 11b is negative, the differential amplitude M1 of the logic “1” bits is reduced to the differential amplitude M′1.

The differential receiver 16 is coupled to the signal output 19a of the first DC coupler 12a and the signal output 19b of the second DC coupler 12b. Typically, the differential receiver 16 includes a differential limiting amplifier A that decodes the logic bits in the differential signal 23 to extract a decoded series of logic states D′.

The differential receiver 16 also includes a data comparator 24 coupled to the output 22 of the differential limiting amplifier A. When the differential amplitude M′0 of the differential signal 23 is sufficiently large, the differential amplifier A provides a logic “0” bit represented in the decoded series of logic states D′ at the output 22, which is consistent with the logic “0” bit present in the series of logic states D in the differential signal 13. However, as the differential amplitude M′0 is reduced, for example by a positive imposed offset V_{OS} of correspondingly increased magnitude, the ability of the differential limiting amplifier A to distinguish between the logic “0” bit and a logic “1” bit becomes increasingly impaired. This impairment is manifested as errors in the detection of the logic “0” bits in the decoded series of logic states D′, which results in the decoded series of logic states D″ deviating from the series of logic states D. When the differential amplitude M′1 of the differential signal 23 is sufficiently large, the differential amplifier A provides a logic “1” bit in the decoded series of logic states D′ at the output 22, which is consistent with the logic “1” bit present in the series of logic states D represented in the differential signal 13. However, as the differential amplitude M′1 is reduced, for example by a negative imposed offset V_{OS} of correspondingly increased magnitude, the ability of the differential limiting amplifier A to distinguish between the logic “1” bit and a logic “0” bit becomes increasingly impaired. This impairment is manifested as errors in the detection of the logic “1” bits in the decoded series of logic states D′, which results in the decoded series of logic states D″ deviating from the series of logic states D.

The data comparator 24 receives the decoded series of logic states D′ from the output 22 of the differential amplifier A and compares the decoded series of logic states D′ to the series of logic states D represented in the differential signal 13. FIG. 2 shows a data clock CLK and the series of logic states D being communicated to the data comparator 24. Based on the comparison performed by the data comparator 24, various measures of errors, or deviations between the decoded series of logic states D″ and the series of logic states D, can be established. For example, error profiles can be created that indicate the sensitivity of errors, in either the logic “0” bits or logic “1” bits, to the imposed offsets V_{OS} or to the resulting differential amplitudes M′0, M′1 of the differential signal 23, by recording deviations between the series of logic states D and the decoded series of logic states D′ as a function of the imposed offsets V_{OS} or resulting differential amplitudes M′0, M′1.

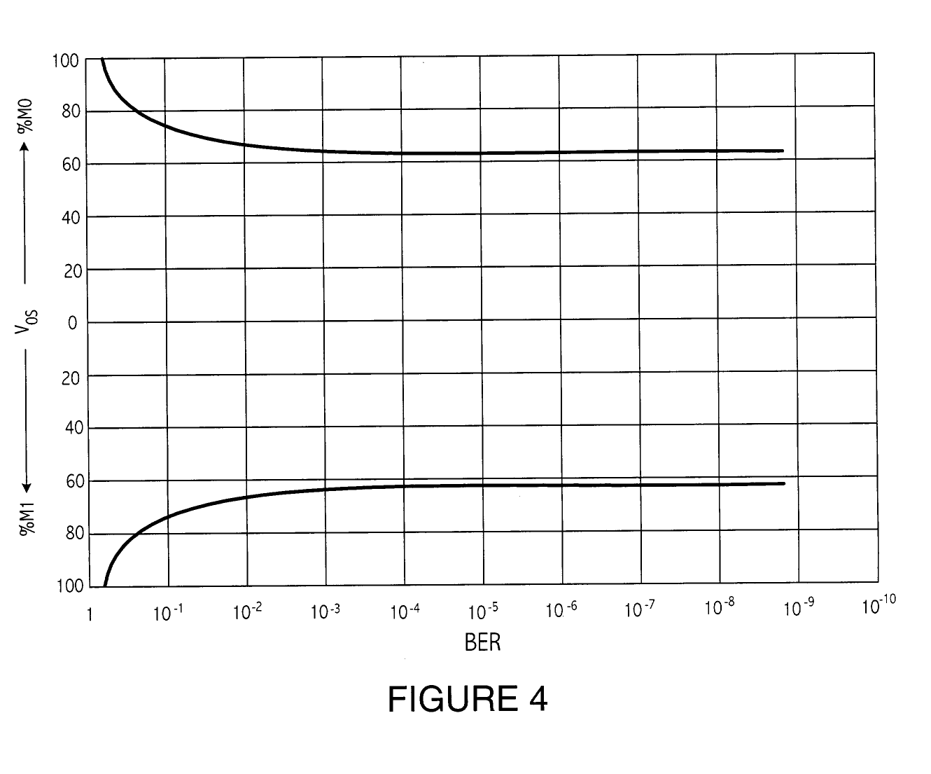

FIG. 4 shows an example of an error profile, wherein the differential receiver 16 establishes the BER at predesignated imposed offsets V_{OS}, by recording the number of bits received in error over time in the series of logic states D′ relative to the total number of bits in the series of logic states D over time, at the predesignated imposed offsets V_{OS}. In FIG. 4, the BER is indicated as a function of the imposed offset V_{OS} expressed relative to the total differential amplitudes M0, M1.

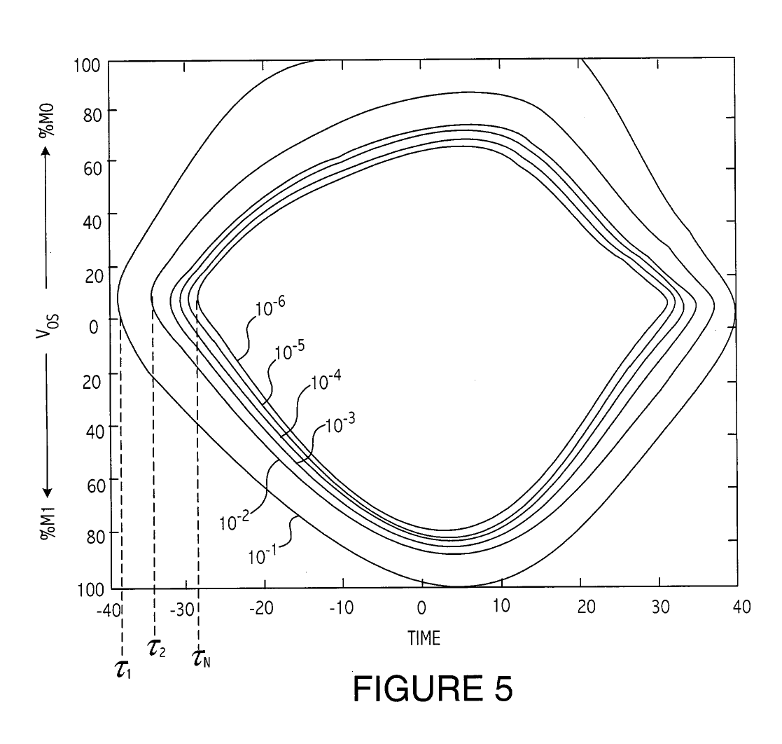

In another example, the differential receiver 16 and pattern generator 20 are implemented using a parallel bit error ratio tester, such as an AGILENT TECHNOLOGIES, INC. model 81250 ParBERT. In this example, the DC source 14, via the DC couplers 12a, 12b, imposes the offset V_{OS} that selectively varies the differential amplitudes M0, M1 of the logic “0” bits and the logic “1” bits encoded in the series of logic states D. A delay element (not shown) in the parallel bit error ratio tester varies the timing of the differential signal 23 provided to the differential receiver 16 relative to the data clock CLK. Errors, or the resulting deviation between the series of data states D and the decoded series of data states D′, induced by the imposed offset V_{OS} and the varied timing of the differential signal 23, can be recorded as a function of the imposed offset V_{OS} and the varied timing to provide one or more error contours. FIG. 5 shows a series of error contours wherein error rates are indicated versus imposed offset V_{OS} and imposed time delays τ₁-τ_{N}. The error contour provides BER, or other statistical measures for the decoded series of data states D′ and can be used to monitor or predict the reliability of a digital communication link or system.

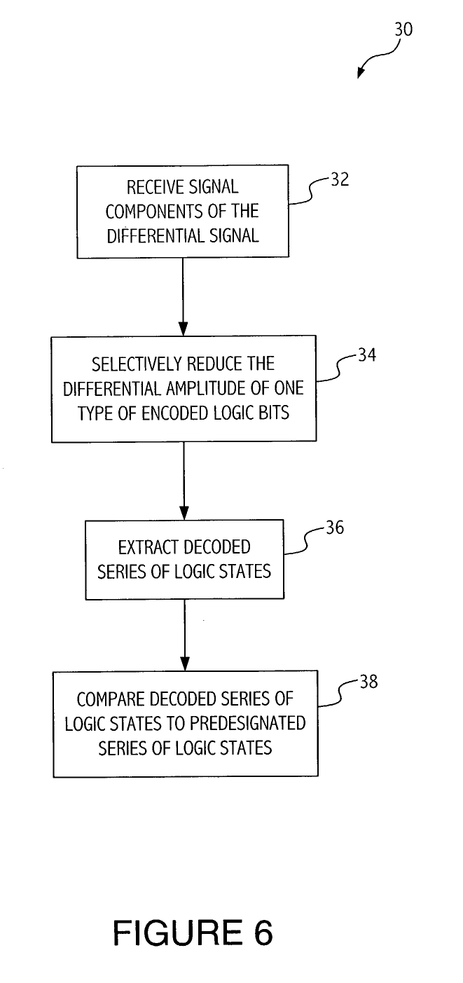

In an alternative embodiment of the present invention, the aspects of the differential error detector 10 are implemented according to a differential error detection method 30, as shown in FIG. 6. In step 32 of the differential error detection method 30, the signal component 11a of a differential signal 13 that represents the predesignated series of logic states D and the signal component 11b of the differential signal 13 that represents the complementary series of logic states \overline{D} are received, wherein the two or more types of logic bits, such as the logic “0” bit and the logic “1” bit, are encoded according the two or more corresponding differential amplitudes between the signal components 11a, 11b, such as the differential amplitudes M0, M1.

In step 34, the differential amplitudes of one of the types of encoded logic bits is selectively reduced, for example the logic “0” bit as shown in FIG. 3D or the logic “1” bit as shown in FIG. 3E. Typically, the differential amplitude is selectively reduced by imposing the offset V_{OS} on the signal components 11a, 11b of the differential signal 13. Varying the magnitude of the imposed offset V_{OS} correspondingly varies the differential amplitude of the encoded logic bits, for example the logic “0” bit, whereas varying the polarity of the imposed offset V_{OS} selectively reduces the differential amplitude of another of the types of encoded logic bits, for example the logic “1” bit.

Step 36 includes extracting the decoded series of logic states D′, once the differential amplitude of one type of encoded bits is selectively reduced. In step 38, the decoded series of logic states is compared to the predesignated series of logic states D represented in the differential signal 13. Deviations between the decoded series of data states D′ and the series of data states D are optionally recorded as a function of the imposed offset V_{OS} to create the error profiles that indicate the sensitivity of errors to the imposed offset V_{OS}. Alternatively, deviations between the decoded series of data states D′ and the series of data states D are optionally recorded as a function the imposed time delays τ₁-τ_{N} and the imposed offset V_{OS} to create the error contours that indicate the sensistivity of errors to the imposed time delays τ₁-τ_{N} and the imposed offsets V_{OS}.

While the embodiments of the present invention have been illustrated in detail, it should be apparent that modifications and adaptations to these embodiments may occur to one skilled in the art without departing from the scope of the present invention as set forth in the following claims.

1. A differential error detector, comprising:
a first DC coupler having a signal input receiving a first signal component of a differential signal representing a predesignated series of logic states;
a second DC coupler having a signal input receiving a second signal component of the differential signal representing a complement of the series of logic states;
wherein at least two types of logic bits are encoded according to at least two corresponding differential amplitudes between the first signal component and the second signal component;
a DC source coupled between a bias input of the first DC coupler and a bias input of the second DC coupler, imposing an offset between the first signal component and the second signal component, selectively reducing the differential amplitude of one of the types of encoded logic bits between a signal output of the first DC coupler and a signal output of the second DC coupler; and
a differential receiver coupled to the signal output of the first DC coupler and the signal output of the second DC coupler, extracting a decoded series of logic states and comparing the decoded series of logic states to the predesignated series of logic states represented in the differential signal.

2. The differential error detector of claim 1 wherein the magnitude of the offset imposed by the DC source is varied to correspondingly vary the differential amplitude of the one of the types of the encoded logic bits.

3. The differential error detector of claim 1 wherein the polarity of the offset imposed by the DC source is varied to selectively reduce the differential amplitude of another of the types of the encoded logic bits.

4. The differential error detector of claim 3 wherein the magnitude of the offset imposed by the DC source is varied to correspondingly vary the differential amplitude of the another of the types of the encoded logic bits.

5. The differential error detector of claim 2 wherein the differential receiver records deviations between the decoded series of data states and the predesignated series of data states as a function of the offset imposed by the DC source.

6. The differential error detector of claim 4 wherein the differential receiver records deviations between the decoded series of data states and the predesignated series of data states as a function of the offset imposed by the DC source.

7. The differential error detector of claim 1 further comprising a pattern generator providing the differential signal, wherein the pattern generator and the differential receiver are implemented in a bit error rate tester.

8. The differential error detector of claim 7 wherein the DC source varies at least one of the magnitude and the polarity of the offset imposed by the DC source and the bit error rate tester varies a timing delay of the differential signal.

9. The differential error detector of claim 8 wherein the bit error rate tester records deviations between the decoded series of data states and the predesignated series of data states as a function of the timing delay of the differential signal and at least one of the magnitude and the polarity of the offset imposed by the DC source, to provide a series of error contours.

10. A differential error detection method for a differential signal, comprising:
receiving a first signal component of a differential signal representing a predesignated series of logic states and a second signal component of the differential signal representing a complement of the series of logic states, wherein at least two types of logic bits are encoded according to at least two corresponding differential amplitudes between the first signal component and the second signal component;
selectively reducing the differential amplitude of one of the types of encoded logic bits;
extracting a decoded series of logic states; and
comparing the decoded series of logic states to the predesignated series of logic states represented in the differential signal.

11. The differential error detection method of claim 10 wherein selectively reducing the differential amplitudes between the first signal component and the second signal component includes imposing an offset between the first signal component and the second signal component.

12. The differential error detection method of claim 11 further including varying the magnitude of the imposed offset to correspondingly vary the differential amplitude of the one of the types of the encoded logic bits.

13. The differential error detection method of claim 11 further including varying the polarity of the imposed offset to selectively reduce the differential amplitude of another of the types of the encoded logic bits.

14. The differential error detection method of claim 13 further including varying the magnitude of the imposed offset to correspondingly vary the differential amplitude of the another of the types of the encoded logic bits.

15. The differential error detection method of claim 12 further comprising recording deviations between the decoded series of data states and the predesignated series of data states as a function of the imposed offset.

16. The differential error detection method of claim 14 further comprising recording deviations between the decoded series of data states and the predesignated series of data states as a function of the imposed offset.

17. The differential error detection method of claim 12 further including imposing a timing delay of the differential signal.

18. The differential error detection method of claim 14 further including imposing a timing delay of the differential signal.

19. The differential error detection method of claim 17 further including establishing a series of error contours based on the imposed time delay of the differential signal and at least one of the magnitude and the polarity of the imposed offset.

20. The differential error detection method of claim 18 further including establishing a series of error contours based on the imposed time delay of the differential signal and at least one of the magnitude and the polarity of the imposed offset.
